(19) United States
(12) Patent Application Publication
(10) Pub. No.: US 2018/0091547 A1
(43) Pub. Date: Mar. 29, 2018

(54) DDOS MITIGATION BLACK/WHITE LISTING BASED ON TARGET FEEDBACK

(71) Applicant: Arbor Networks, Inc., Burlington, MA (US)

(72) Inventor: Brian St. Pierre, Acworth, NH (US)

(21) Appl. No.: 15/276,522

(22) Filed: Sep. 26, 2016

(51) Int. Cl. H04L 29/06

(52) U.S. Cl. CPC H04L 63/1458; H04L 63/0227; H04L 63/1416; H04L 63/101

(57) ABSTRACT

A system for mitigating network attacks is provided. The system includes a protected network including a plurality of devices. The system further includes one or more attack mitigation devices communicatively coupled to the protected network. The attack mitigation devices are configured and operable to monitor a plurality of messages exchanged between an external device and a protected device in the protected network. The attack mitigation devices are further configured to parse messages received from the protected device to identify a status flag indicative of malicious characteristic of message requests sent by the external device. The attack mitigation devices are also configured to determine malicious characteristic of the external device based on the identified status flag and to insert network address of the external device into either a first list or a second list based on the determined malicious characteristic of the external device.

### FIELD OF THE INVENTION

Embodiments of the present elate generally to computer and network security, and, specifically, to a distributed denial-of-service (DDoS) mitigation black/white listing based on target feedback.

### BACKGROUND OF THE INVENTION

A Denial of Service (DoS) attack is typically an attempt to make a network machine or network resource unavailable to intended users. Generally speaking, a DoS attack is an attempt to overwhelm the capacity of a server in order to interrupt or suspend functioning of network resources associated with the server. Traditional methods for detecting DoS attacks are typically based on monitoring incoming traffic and detecting the DoS attack based on an observation of a large increase in traffic, especially when a large portion of the traffic originates from a single IP address. In this case, mitigating the DoS attack includes filtering out the traffic associated with any IP addresses identified as malicious.

A DDoS attack is a more aggressive action that involves multiple offensive devices performing an attack on a single target computer network or system. This attack may be performed in a coordinated manner by these multiple external devices to attack a specific resource of a service provider network. The targeted resource can be any networking device such as routers, Internet servers, electronic mail servers, DNS servers, etc. Examples of a DDoS attack include (but are not limited to): large quantities of raw traffic designed to overwhelm a resource or infrastructure; application specific traffic designed to overwhelm a particular service; traffic formatted to disrupt a host from normal processing; traffic reflected and/or amplified through legitimate hosts; traffic originating from compromised sources or from spoofed IP addresses; and pulsed attacks (which start/stop attacks).

Conventionally, a variety of approaches have been employed to detect attacks on infrastructure of protected networks. For example, to detect incoming attacks, network service providers have adopted a defense-in-depth approach by deploying, 1) commercial hardware devices (e.g., firewalls, Intrusion Detection Systems (IDS), DDoS attack mitigation devices, etc.) at the network level; and 2) proprietary software (e.g., host-based IDS, anti-malware) at the host level. The above-mentioned hardware devices analyze inbound traffic to protect against a variety of attacks, such as TCP Stack Flood Attacks (e.g., flood a certain aspect of a TCP connection process to keep the host from being able to respond to legitimate connections (which may also be spoofed)); Generic Flood Attacks (e.g., consists of a flood of traffic for one or more protocols or ports, which may be designed to appear like normal traffic which may also be spoofed)); Fragmentation Attacks (e.g., consists of a flood of TCP or UDP fragments sent to a victim to overwhelm the victim's ability to re-assemble data streams, thus severely reducing performance); Application Attacks (e.g., attacks designed to overwhelm components of specific applications); Connection Attacks (e.g., attacks that maintain a large number of either ½ open TCP connections or fully open idle connections); and Vulnerability Exploit Attacks (e.g., attacks designed to exploit a vulnerability in a victim's operating system). To block unwanted traffic, service providers utilize a combination of mitigation mechanisms, such as Access Control Lists (ACLs), blacklists and whitelists, rate limiters, and/or traffic redirection to scrubbers for deep packet inspection (DPI) (e.g. malware detection).

However, DPI techniques used for DDoS attack mitigation can prove to be expensive in terms of CPU cycles. Typically, the use of DPI during a DDoS attack creates bottlenecks in two places: (a) congestion in the communication link between the provider edge router and the mitigation device, and (b) exhaustion of resources such as CPU cycles and memory on the mitigation device. These bottlenecks significantly reduce the effective performance of the mitigation device, and thus, its usefulness. As a result, service providers are unable to reliably and cost-effectively mitigate DDoS attacks.

### SUMMARY OF THE INVENTION

The purpose and advantages of the illustrated embodiments will be set forth in and apparent from the description that follows. Additional advantages of the illustrated embodiments will be realized and attained by the devices, systems and methods particularly pointed out in the written description and claims hereof, as well as from the appended drawings.

In accordance with a purpose of the illustrated embodiments, in one aspect, a system for handling requests to a protected network is provided. The system includes a protected network including a plurality of devices. The system further includes one or more attack mitigation devices communicatively coupled to the protected network. The attack mitigation devices are configured and operable to monitor a plurality of messages exchanged between an external device and one of the plurality of devices in the protected network. The external device attempts to access the one of the plurality of devices in the protected network. The attack mitigation devices are further configured to parse messages received from the protected device to identify a status flag indicative of malicious characteristic of message requests sent by the external device. The attack mitigation devices are also configured to determine malicious characteristic of the external device based on the identified status flag and to insert network address of the external device to either a first list or a second list based on the determined malicious characteristic of the external device.

In another aspect, a system for mitigating network attacks is provided. The system includes a protected network including a plurality of devices. The system further includes one or more attack mitigation devices communicatively coupled to the protected network. The attack mitigation devices are configured and operable to receive diverted message request from an external device destined to one of the plurality of devices in the protected network. The external device attempts to access one or more protected devices in the protected network. The attack mitigation devices are further configured to determine whether the diverted message request is directed to a first protected network resource and to insert network address of the external device into a first list, responsive to determination that the diverted message request is directed to the first protected network resource. The first protected network resource is associated with a first malicious characteristic of the external device. The attack mitigation devices are also configured to determine whether the diverted message request is directed to a second protected network resource, responsive to determination that the diverted message is not directed to the first protected network resource, and to insert network address of the external device into a second list, responsive to determination that the diverted message request is directed to the second protected network resource. The second protected network resource is associated with a second malicious characteristic of the external device.

### BRIEF DESCRIPTION OF THE DRAWINGS

The accompanying appendices and/or drawings illustrate various, non-limiting, examples, inventive aspects in accordance with the present disclosure:

FIG. 1 is a schematic diagram showing a network architecture having mitigation devices deployed in line with protected network traffic flows, according to one embodiment of the present invention;

FIG. 2 is a schematic diagram showing another network architecture network traffic flows destined to a protected network are diverted to a mitigation device, according to another embodiment of the present invention;

FIG. 3 is a flow diagram illustrating the steps performed by the attack mitigation device of FIG. 1 during an attack, according to an embodiment of the present invention;

FIG. 4 is a flow diagram illustrating the steps performed by the attack mitigation device of FIG. 2 during an attack, according to an embodiment of the present invention;

FIG. 5 is a block diagram of the attack mitigation device of FIGS. 1 and 2, in accordance with an embodiment of the present invention.

### DETAILED DESCRIPTION OF CERTAIN EMBODIMENTS

The present invention is now described more fully with reference to the accompanying drawings, in which illustrated embodiments of the present invention are shown wherein like reference numerals identify like elements. The present invention is not limited in any way to the illustrated embodiments as the illustrated embodiments described below are merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described below. One skilled in the art will appreciate further features and advantages of the invention based on the below-described embodiments. Accordingly, the invention is not to be limited by what has been particularly shown and described, except as indicated by the appended claims.

In exemplary embodiments, a computer system component may constitute a “module” that is configured and operates to perform certain operations as described herein below. Accordingly, the term “module” should be understood to encompass a tangible entity, be that an entity that is physically constructed, permanently configured (e.g., hardwired) or temporarily configured (e.g. programmed) to operate in a certain manner and to perform certain operations described herein.

It is to be further understood the illustrated embodiments of the present invention describe a system, apparatus and method for avoiding and mitigating the harmful effects of a DDoS attack on a computer system/device or network.

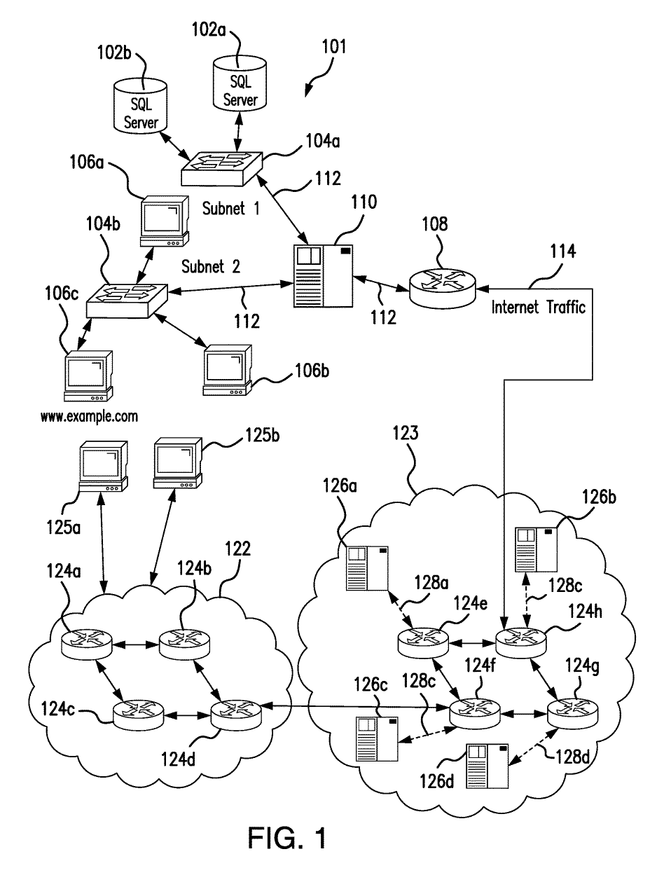

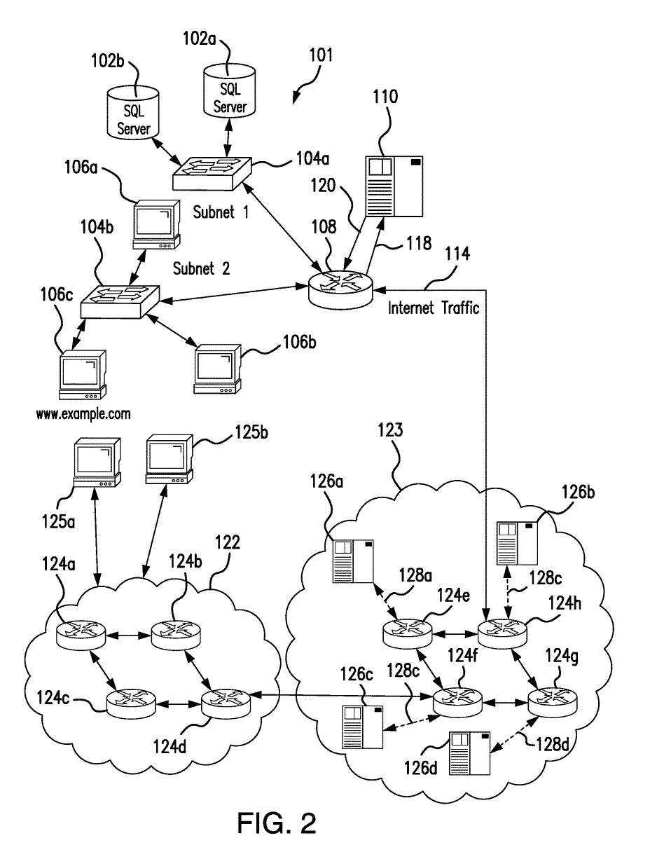

Turning now descriptively to the drawings, in which similar reference characters denote similar elements throughout the several views, FIGS. 1-2 show different network architectures to which the present invention is applicable. Each shows the relationship between the internet 122, service provider network 123, attack mitigation device 110, and protected network 101.

In FIG. 1, one or more external devices 125a, 125b attempt to connect to the protected network 101 and specifically a device within the network 101. In the illustrated example, the external devices 125a, 125b connect via the Internet 122, which is comprised of third-party communication devices (numerals 124a-d), such as the communications devices of an enterprise network and/or other public and private service provider networks.

Connecting the protected network 101 to the internet 122 is a service provider network 123 (service provider). Within the service provider network, communication devices 124e-h provide the data communication and specifically transmit packets across the network 123.

In one example, multiple sensors 126a-d are connected to or associated with communications devices 124e-h, such as routers, of the service provider network 123. The sensors 126 communicate with their associated communication devices 124 via communication paths 128a-d to monitor the network traffic handled by the routers 124. In one example, the sensors 126a-d monitor total traffic levels, IP address destinations and/or origins, bitrates, and browsers being used, to list a few examples, and are used by the service provider to implement security policies across its network 123. Here, the sensors 126 are further used to deploy network resources for mitigating denial of service attacks to protect the network 101 and its users.

The service provider network 123 connects to a protected communications device 108, typically a router, of the protected network 101 through a network connection or link 114. Additionally, the router 108 also interconnects the subnetworks (i.e., subnet 1, subnet 2) defined by switches 104a, 104b in the case of an enterprise network for example. Subnetworks (or subnets) are subdivisions within the larger protected network 101. In the illustrated example, subnet 1 includes a switch 104a and SQL servers 102a, 102b. Subnet 2 includes a switch 104b and computer workstations 106a, 106b.

In the illustrated implementation, the attack mitigation device 110 is connected inline between the router 108 and one or more subnets on the protected network 101. When deployed inline, the mitigation device 110 decides on a per-packet basis for all packets entering or leaving the protected network 101 whether to block (drop the packet) or forward (pass to the next-hop device).

In one embodiment, the attack mitigation device 110 may be configured to utilize DPI techniques for DDoS attack mitigation. However, as noted above, DPI techniques used for DDoS attack mitigation can prove to be expensive in terms of CPU cycles and memory usage and can create communication bottlenecks. These communication bottlenecks significantly reduce the effective performance of the mitigation device 110, and thus, its usefulness. One known mitigation strategy, as a compliment to DPI, includes offloading a blacklist of “bad” source network addresses to other network elements, such as, for example, communications devices 124e-h, that are configured to merely drop the attack traffic based on the blacklist, if such blacklist can be built, thusly reducing communication bandwidth and wasted CPU cycles on the attack mitigation device 110, if such blacklist can be built. Similarly, if a whitelist of “good” source network addresses can be built by the attack mitigation device 110, then that list can also be offloaded to a more generic network element, such as one or more of suitable communications devices 124e-h, saving resources on the attack mitigation device 110 for detection and prevention of DDoS attacks. Even when black/white lists cannot be offloaded by the attack mitigation device 110, it is still less resource intensive for the mitigation device 110 to drop or pass a packet when the address shows up on respective lists than it is to perform DPI or a potentially more disruptive active countermeasure.

One aspect of the problem associated with black/white lists is that the identification of a particular source as either malicious (“bad”) or safe (“good”) can be challenging for the attack mitigation device 110, at least in some cases. When possible, users could manually configure black/white list addresses, but manual configuration typically does not scale well.

Advantageously, the ensuing description of the exemplary embodiments will provide those skilled in the art with an enabling description for implementing novel mitigation mechanisms where various elements of the protected network 101 can provide feedback to the attack mitigation device 110, so that the mitigation device 110 can automatically develop at least one of or both a blacklist and a whitelist during the course of an attack. These novel methods contemplate that the attack mitigation device 110 will utilize expensive DPI processing exclusively to inspect and classify the portion of the traffic that cannot be easily categorized by the protected network 101. It will be understood that various changes may be made in the function and arrangement of various network elements without departing from the spirit and scope as set forth in the appended claims.

In one embodiment, at least some of the packets transmitted by a protected element provide feedback facilitating automatic development of white/black lists by the attack mitigation device 110. In other words, in one embodiment, the communications path 112 delivers monitored status messages to the attack mitigation device 110 that contain information indicating whether a given address is determined to be safe or malicious as described below. In various embodiments, the protected elements may be configured to make a decision related to detection of security threats (attacks) upon examining the network data and identifying certain security events, such as, but not limited to, a protocol length mismatch, a protocol value violation, a value violation for a protocol in a given state, a protocol state transition violation, a firewall rule violation, a known bad piece of network data, or a piece of network data decided to be bad.

FIG. 2 shows an alternative architecture to which embodiments of the present invention are applicable. Here, the incoming network traffic received through communication channel 114 and destined to the protected network 101 is diverted to the attack mitigation device 110 to detect improper activity and then selectively placed back into the protected network 101. The attack mitigation device 110 receives off-ramped traffic through a communication channel 118 and dynamically builds white/black lists and/or performs DPI processing. At least in some embodiments, the attack mitigation device 110 then removes the attack traffic (i.e., traffic associated with the internal blacklist or determined to be “bad” via DPI processing). The legitimate traffic (i.e., traffic associated with the internal whitelist or determined to be safe via DPI processing) is then returned back to the protected network 101 through a communication channel 120. In some examples, the attack mitigation device 110 removes or drops packets from the source IP addresses specified in the blacklist, packets with source and destination IP addresses specified in the blacklist, packets with specified payloads, and/or packets for ports specified in the internal blacklist.

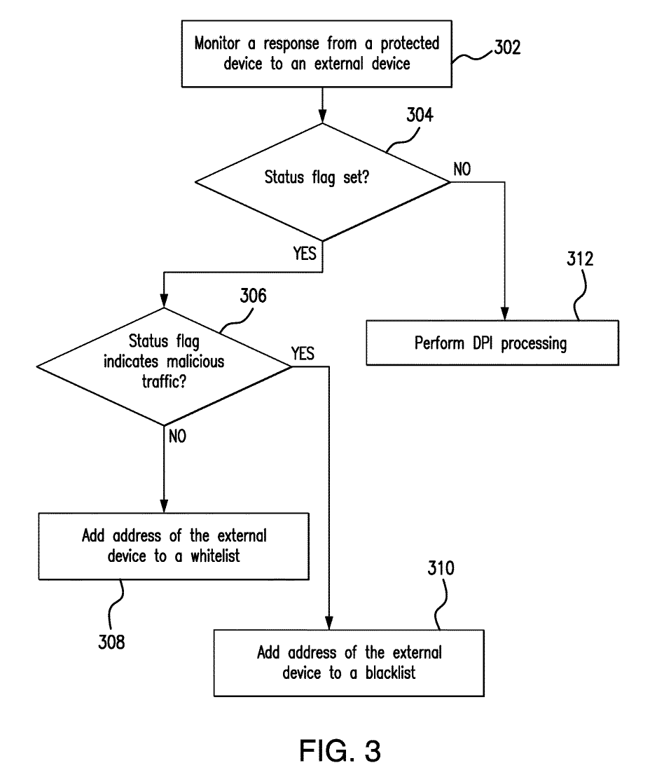

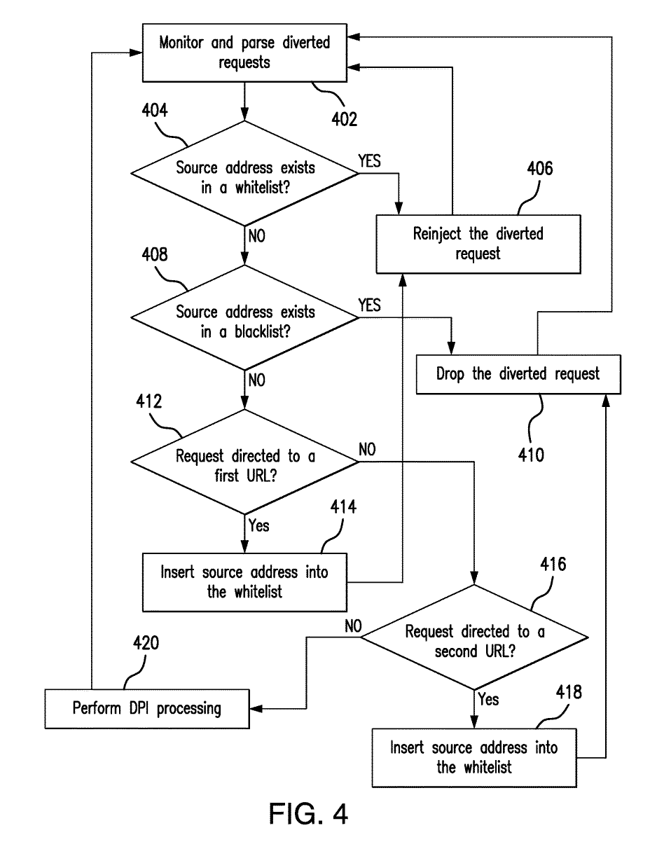

FIG. 3 is a flow diagram illustrating the steps performed by the attack mitigation device of FIG. 1 deployed inline during an attack, according to one embodiment of the present invention and FIG. 4 is a flow diagram illustrating the steps performed by the attack mitigation device of FIG. 2 processing diverted traffic during an attack, according to alternative embodiment of the present invention. Before turning to descriptions of FIGS. 3 and 4, it is noted that the flow diagrams in FIGS. 3 and 4 show examples in which operational steps are carried out in a particular order, as indicated by the lines connecting the blocks, but the various steps shown in these diagrams can be performed in any order, or in any combination or sub-combination. It should be appreciated that in some embodiments some of the steps described below may be combined into a single step. In some embodiments, one or more additional steps may be included.

Generally described, to mitigate DDoS attacks, mitigation technique described below may be employed to improve mitigation device's performance. Such techniques may apply to many suitable protocols and many different types of protected devices capable of communicating (directly or indirectly) with the attack mitigation device 110. Starting with FIG. 3, steps 302-312 described below are applicable to inline deployment of the mitigation device 110 and indirect communication scheme between the attack mitigation device 110 and one or more protected communication devices.

In an inline configuration, the attack mitigation device 110 is configured to monitor attempted inter-network communications. Attempted inter-network communications can include attempts by devices internal to the protected network 101 to communicate with resources external to the protected network 101 and attempts by devices external to the protected network 101 to establish communication sessions with resources internal to the protected network 101. Attempts by devices external to the protected network 101 to communicate with resources internal to the protected network 101 can be detected by identifying network traffic employing, for example, but not limited to, HTTP (Hypertext Transfer Protocol) or HTTPS (HTTP Secure) protocols or network traffic on specific ports of protected devices (i.e., port 80).

More specifically, in step 302, the attack mitigation device 110 is configured to monitor responses, such as HTTP responses, from the protected devices, such as host 106c, to the one or more external devices 125a, 125b. In some embodiments, all of the devices internal to the protected network 101 are configured to send, responsive to incoming requests, enhanced protocol messages with an agreed-upon flag (referred to hereinafter as the “status flag indicative of malicious characteristic of corresponding message requests” or simply “status flag”) to signal malicious characteristic of given source traffic (i.e., the received incoming requests). For example, if a web server, such as host 106c, is the protected element and the host 106c detects through its own internal logic that a source of an incoming request is malicious, the host 106c could reply with an enhanced protocol response message which includes special HTTP status code that indicates to the mitigation device 110 that the source address should be blacklisted. Some special status codes can include, for example, 401—Unauthorized, 403—Forbidden, or 406—Not Acceptable. Similarly, if the host 106c gets a valid user login from a given source address, the host 106c can then notify the attack mitigation device 110 if the given source address should be whitelisted by redirecting the received request to dedicated content sources/application servers (e.g., including URLs/content) that are configured to be monitored by the attack mitigation device 110. Similar rules to decide between safe and malicious traffic from various sources may also be implemented and executed by other devices internal to the protected network 101. This way the attack mitigation device 110 does not need to perform expensive DPI processing if the request is from the source that is monitored and that has been flagged by protected devices as good/bad.

Accordingly, in step 304, the attack mitigation device 110 may parse the response messages transmitted by the protected devices to identify a status flag indicative of malicious characteristic of message requests being sent by the external devices 125a, 125b. In an embodiment, in this step, the received response message(s) may be parsed by the attack mitigation device 110 to determine whether a status flag is set. It should be noted that an unset status flag reflects undetermined malicious characteristic of the external device.

In response to determining that the status flag is set (decision block 304, “Yes” branch), the attack mitigation device 110 may determine next whether the set status flag identifies traffic that is recognizably malicious (step 306). In one example, the status flag may be set to “true” when the original request message source is determined as being malicious by one of the protected devices and may be set to “false” when the original request message source is determined as being safe by one of the protected devices. In one embodiment, a firewall of the protected network 101 may make the determination in conjunction with an access control list.

According to an embodiment of the present invention, responsive to a determination that the status flag is set to true (decision block 306, “Yes” branch), the attack mitigation device 110 is configured to add a source IP address of the original request message to a blacklist in step 310. Similarly, responsive to a determination that the status flag is set to false (decision block 306, “No” branch), the attack mitigation device 110 is configured to add a source IP address of the original request message to a blacklist. In some embodiments, the blacklist may comprise an access control list or deny list of users, clients, IP addresses, MAC addresses, or other identifiers of external devices associated with a detected DDoS attack that should be prevented from access to the protected network 101. In other embodiments, the access control list may comprise a whitelist or allow list of external devices that should be allowed access to the protected network 101, with all other external devices being prevented. Accordingly, being blacklisted may refer either to being on a blacklist or deny list or not being on a whitelist or allow list with a policy that blocks all external devices not on said whitelist. In one embodiment, if the external device 125a, 125b is blacklisted or denied by the access control list, then the attack mitigation device 110 may drop the requests associated with this external device.

According to an embodiment of the present invention, if the status flag is not set at all (decision block 304, “No” branch), in step 312, the attack mitigation device 110 may perform DPI processing on individual packets to identify malicious characteristics of the monitored requests from the external devices 125a, 125b. As a non-limiting example, the individual packets can be analyzed by the attack mitigation device 110 to find keywords which appear in the packets carrying layer-7 protocols data. The analysis may be performed on the header and/or payload portions of the packets. For instance, TCP packets can be analyzed to detect signatures or patterns of DDoS attacks intended to harm devices internal to the protected network 101. Other examples for performing DPI on the monitored packets will be apparent to one of ordinary skill.

In the illustrated embodiment, the communications protocol is HTTP. However, the invention is not so limited. For example, communication protocol may be Real-time Transport Protocol (or RTP), or any of a variety of other protocols with usable extensible fields to contain a status flag indicative of traffic's malicious characteristics that may allow the attack mitigation device 110 make a decision related to blacklisting/whitelisting certain external devices. It will be appreciated that other protocols may be used as long as the attack mitigation device 110 can be configured to look for certain patterns that devices on the protected network 101 can utilize to distinguish between safe and malicious sessions. For example, the protected devices may reply to DNS queries with a certain hostname pattern in the response to indicate malicious characteristics of the corresponding session. Advantageously, the above described capabilities can be built into existing proprietary applications and proprietary security products. For example, continuing the example above, single-server or multi-server host 106c merely needs to be configured to provide storefront applications and/or virtual applications that are capable of redirecting client requests through a login URL that is configured on the attack mitigation device 110. With respect to traffic with detected malicious intent, a change in the middleware or utilization of a webserver plugin capable of returning one of the special status codes described above would suffice.

As an alternative to steps 302-312 described above, inline deployment of the mitigation device 110 may utilize direct communication scheme between the attack mitigation device 110 and one or more protected communication devices. This signaling scheme requires the attack mitigation device 110 to process a plurality of signaling messages with malicious characteristic information sent directly from network elements internal to the protected network 101 using a special secure signaling protocol. In one embodiment, this signaling functionality can be implemented via one or more APIs, so that each protected device can essentially be made to directly talk to the attack mitigation device 110 through a standardized interface that permits notifications of detected malicious characteristics of requests received from external devices, all on a completely automated basis. The details of such secure signaling protocol and/or such APIs will be apparent to one of ordinary skill, but it is contemplated by this communication scheme that essentially all of the protected elements should be capable of sending status messages characterizing traffic that exhibits characteristics associated with a malicious attack, such as characteristics associated with a DDoS attack, and should be capable of notifying the attack mitigation device 110 whether to blacklist or whitelist corresponding source addresses, when the protected devices determine such malicious characteristics. The advantage of this approach is that if malicious characteristic information is determined to be available then the attack mitigation device 110 can use such signaling protocol to send requests for malicious characteristics information and/or for a list of black/white listed source addresses directly to one or more protected network resources/elements/functions. Such a strategy increases aggregate network capacity for the protected network 101.

FIG. 4 is a flow diagram illustrating the steps performed by the attack mitigation device of FIG. 2 processing diverted traffic during an attack, according to yet another alternative embodiment of the present invention. In this diversion implementation, the network traffic is diverted to the attack mitigation device 110 through the communication channel 118 and then selectively reinjected back into the protected network 101 through the communication channel 120, as shown in FIG. 2. In this case a different approach is used because the monitoring attack mitigation device 110 typically does not see return traffic from the protected element destined to the source of received requests, which makes it harder to understand malicious characteristics of the traffic. According to an embodiment of the present invention, in diversion deployment architecture, the protected element, such as host 106c, can signal the source of the received requests to make a specific request that the attack mitigation device 110 will be able to see and know whether to blacklist or whitelist the corresponding source address. In one example, a web server (i.e., an Apache web server) could redirect requests of a malicious client to a first URL (or any other first protected network resource) that is monitored by and is configured in the attack mitigation device 110 to trigger blacklisting of the client, or to redirect an authenticated client to a second monitored URL (or any other second protected network resource) that allows the attack mitigation device 110 to whitelist non-suspect clients that successfully complete authentication by the web server.

More specifically, in step 402, the attack mitigation device 110 is configured to monitor and parse diverted requests, such as but not limited to HTTP or DNS requests, from the one or more external devices 125a, 125b to the protected devices, such as host 106c.

According to an embodiment of the present invention, the attack mitigation device 110 maintains an internal whitelist and an internal blacklist. Both the internal whitelist and the internal blacklist are populated automatically by the attack mitigation device 110. Once the attack mitigation device 110 determines a source IP address of the diverted request, in step 404, the attack mitigation device 110 makes a determination if the source address of the diverted request already exists in the whitelist maintained by the attack mitigation device 110. In response to determining that protected resources are requested by one of the whitelisted external devices (decision block 404, “Yes” branch), such request is reinjected back into the protected network 110 by the attack mitigation device 110 in step 406.

In response to determining that the diverted request contain the source IP that has not been whitelisted (decision block 404, “No” branch), in step 408, the attack mitigation device 110 determines if the source address of the external device contained in the diverted request already exists in the blacklist maintained by the attack mitigation device 110. In response to determining that protected resources are requested by one of the blacklisted external devices (decision block 408, “Yes” branch), such request is dropped by the attack mitigation device 110 in step 410 to mitigate the attack, according to an embodiment of the present invention. Any source addresses that are not in the internal whitelist or blacklist are treated as gray requests.

According to an embodiment of the present invention, responsive to determining that the diverted request is a gray request because it contains the source IP that has not been either whitelisted or blacklisted (decision block 408, “No” branch), the attack mitigation device 110 compares the URL contained in the request with a dedicated first URL or URL matching a first pattern based on the destination information obtained in step 402 (step 412). In other words, in step 412, the attack mitigation device 110 determines whether the currently processed request is a notification from the protected element (via client's redirection) that the corresponding source address should be whitelisted. If the request is directed to the first dedicated URL (decision block 412, “Yes” branch), the attack mitigation device 110 inserts the source IP address of the request message into the internal whitelist in step 414 and reinjects the request in step 406.

In response to determining that the diverted gray request is not directed to the first URL (decision block 412, “No” branch), the attack mitigation device 110 compares the URL contained in the request with a dedicated second URL in step 416. In this case, the attack mitigation device 110 determines whether the currently processed request is a notification from the protected element that the corresponding source address should be blacklisted. If the request is directed to the second dedicated URL or URL matching a second pattern (decision block 416, “Yes” branch), the attack mitigation device 110 adds the source IP address of the request message to the internal blacklist in step 418 and continues to step 410 to drop this request.

An alternative embodiment could substitute checking for URLs in decision blocks 412 and 416 with checking for protocol patterns such as matching hostnames in DNS requests that a device within the protected network 101 triggers an external device 125a or 125b to request.

If the diverted gray request is not directed to either of the dedicated URLs, then the protected devices have not been able to determine malicious characteristics of external device's request. According to an embodiment of the present invention, if the request is not destined to the second URL (decision block 416, “No” branch), the attack mitigation device 110 may perform DPI processing on individual packets to identify malicious characteristics of the monitored requests from the external devices in step 420. Some examples for performing DPI on the diverted packets are discussed above in conjunction with FIG. 3. Further, according to an embodiment of the present invention, once the attack mitigation device 110 either reinjects the request back into the protected network 101 (step 406) or drops the request (step 410) or performs DPI inspection (step 420), the attack mitigation device returns to step 402 in order to parse next diverted request.

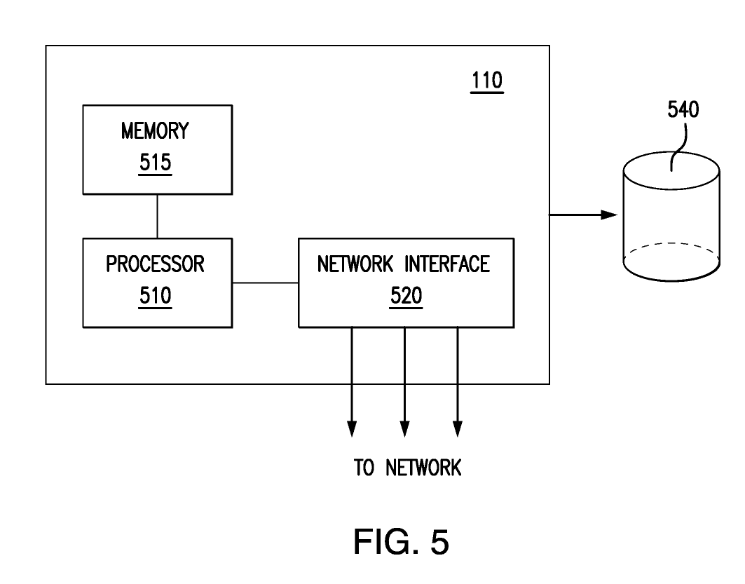

With reference now to FIG. 5, illustrated is an exemplary and non-limiting block diagram of the attack mitigation device 110 constructed according to an illustrated embodiment. The attack mitigation device 110 is communicatively coupled to the protected network 101 and to the database 540 (i.e., storage medium storing whitelist and blacklist information), as shown in FIG. 5, and is at least configured to execute the method for mitigating network attacks as described in greater detail above. The attack mitigation device 110 preferably includes a processor 510 coupled to a memory 515 and a network-interface module 520. The network-interface module 520 allows the communication with the protected network 101. The processor 510 uses instructions stored in the memory 515 to execute attack detection tasks as well as to control and enable the operation of the network-interface module 520.

In summary, various embodiments of the present invention disclose a novel approach of performing packet analysis to identify a potential attack that can reduce the amount of costly DPI analysis performed per-packet by utilizing feedback provided by the protected devices. The disclosed approach provides a number of advantages. In one aspect, software programming code embodying the present invention provides an ability to detect an attack by using various detection methods implemented by the variety of protected devices, which are highly likely to be reliable. In another aspect, if the protected devices and the attack mitigation device 110 are unable to communicate directly, at least some embodiments of the present invention, provide a mechanism for the protected devices to notify the attack mitigation device 110 if a given source address should be whitelisted or blacklisted by redirecting the received request to dedicated content sources/application servers that are configured to be monitored by the attack mitigation device 110. As yet another advantage, although the method depicted in FIGS. 3 and 4 are described with reference to the HTTP protocol, they are not limited thereto. The disclosed processing functionality performed by the attack mitigation device 110 may be applicable to other protocols with useable extensible fields to contain a status flag indicative of traffic's malicious characteristics that may allow the attack mitigation device 110 make a decision related to blacklisting/whitelisting certain external devices.

Most preferably, the various embodiments disclosed herein can be implemented as any combination of hardware, firmware, and software. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system for mitigating network attacks, the system comprising:
a protected network comprising a plurality of devices; and
one or more attack mitigation devices communicatively coupled to the protected network, wherein the one or more attack mitigation devices are configured and operable to:
monitor a plurality of messages exchanged between an external device and one of the plurality of devices in the protected network, wherein the external device attempts to access the one of the plurality of devices in the protected network;
parse messages received from the protected device to identify a status flag indicative of malicious characteristic of message requests sent by the external device;
determine malicious characteristic of the external device based on the identified status flag; and
insert network address of the external device to either a first list or a second list based on the determined malicious characteristic of the external device.

2. The system as recited in claim 1, wherein the first list comprises a whitelist of network addresses of external devices and the second list comprises a blacklist of network addresses of external devices.

3. The system as recited in claim 1, wherein the one or more attack mitigation devices are configured and operable to determine malicious characteristic of the external device and to insert the network address of the external device responsive to a determination the identified status flag is set and wherein an unset status flag is indicative of undetermined malicious characteristic of the external device.

4. The system as recited in claim 3, wherein the one or more attack mitigation devices are further configured and operable to perform Deep Packet Inspection (DPI) processing of the message requests received from the external device to identify malicious characteristic of the external device, responsive to determination that the status flag is unset.

5. The system as recited in claim 1, wherein the protected device sends the status flag using an enhanced communication protocol message.

6. The system as recited in claim 5, wherein the enhanced communication protocol is Hypertext Transfer Protocol (HTTP) and wherein the status flag comprises a predefined HTTP status code.

7. The system as recited in claim 1, wherein the parsed messages received from the protected device comprise in-band messages.

8. A system for handling requests to a protected network, the system comprising:
a protected network comprising a plurality of devices; and
one or more attack mitigation devices communicatively coupled to the protected network, wherein the one or more attack mitigation devices are configured and operable to:
receive diverted message request from an external device destined to one of the plurality of devices in the protected network, wherein the external device attempts to access the one of the plurality of devices in the protected network;
determine whether the diverted message request is directed to a first protected network resource, wherein the first protected network resource is associated with a first malicious characteristic of the external device;
insert network address of the external device into a first list, responsive to determination that the diverted message request is directed to the first protected network resource;
determine whether the diverted message request is directed to a second protected network resource responsive to determination that the diverted message is not directed to the first protected network resource, wherein the second protected network resource is associated with a second malicious characteristic of the external device; and
insert network address of the external device into a second list, responsive to determination that the diverted message request is directed to the second protected network resource.

9. The system as recited in claim 8, wherein the first list comprises a whitelist of network addresses of external devices and the second list comprises a blacklist of network addresses of external devices.

10. The system as recited in claim 8, wherein the one or more attack mitigation devices are further configured and operable to perform Deep Packet Inspection (DPI) processing of the diverted message request to identify malicious characteristic of the external device, responsive to determination that the diverted message request is not directed to the first protected network resource and is not directed to the second protected network resource.

11. The system as recited in claim 9, wherein the one or more attack mitigation devices are further configured and operable to, prior to determining whether the diverted message request is directed to the first protected network resource, determine whether the network address of the external device exists in the first list.

12. The system as recited in claim 11, wherein the one or more attack mitigation devices are further configured and operable to send the diverted message request to the one of the plurality of devices in the protected network, responsive to determination that the network address of the external device exists in the first list.

13. The system as recited in claim 9, wherein the one or more attack mitigation devices are further configured and operable to, prior to determining whether the diverted message request is directed to the first protected network resource, determine whether the network address of the external device exists in the second list.

14. The system as recited in claim 13, wherein the one or more attack mitigation devices are further configured and operable to drop the diverted message request from the external device, responsive to determination that the network address of the external device exists in the second list.

15. An attack mitigation device communicatively coupled to a protected network, the attack mitigation device comprising logic integrated with and/or executable by a processor, the logic being adapted to:
monitor a plurality of messages exchanged between an external devices and one of the plurality of devices in the protected network, wherein the external device attempts to access the one of the plurality of devices in the protected network;
parse messages received from the protected device to identify a status flag indicative of malicious characteristic of message requests sent by the external device;
determine malicious characteristic of the external device based on the identified status flag; and
insert network address of the external device to either a first list or a second list based on the determined malicious characteristic of the external device.

16. The attack mitigation device as recited in claim 15, wherein the first list comprises a whitelist of network addresses of external devices and the second list comprises a blacklist of network addresses of external devices.

17. The attack mitigation device as recited in claim 15, wherein the logic is adopted to determine malicious characteristic of the external device and to insert the network address of the external device responsive to a determination the identified status flag is set and wherein an unset status flag is indicative of undetermined malicious characteristic of the external device.

18. The attack mitigation device as recited in claim 17, wherein the logic is further adopted to perform Deep Packet Inspection (DPI) processing of the message requests received from the external device to identify malicious characteristic of the external device, responsive to determination that the status flag is unset.

19. The attack mitigation device as recited in claim 15, wherein the protected device sends the status flag using an enhanced communication protocol message.

20. The attack mitigation device as recited in claim 19, wherein the enhanced communication protocol is HTTP and wherein the status flag comprises a predefined HTTP status code.
